(19) United States
(12) Patent Application Publication
(10) Pub. No.: US 2010/0143647 A1
(43) Pub. Date: Jun. 10, 2010

(54) LABELS WITH WATER-SOLUBLE UV CURABLE ADHESIVES

(75) Inventors: Holger Tonniessen, Niederzier (DE); Annie Seiler, Duesseldorf (DE); Rainer Rauberger, Duesseldorf (DE); Ralf Grauel, Hilden (DE)

Correspondence Address: HENKEL CORPORATION, One Henkel Way, ROCKY HILL, CT, 06067, US

(73) Assignee: Henkel AG & Co. KGaA, Duesseldorf (DE)

(21) Appl. No.: 12/643,549

(22) Filed: Dec. 21, 2009

Related U.S. Application Data
(63) Continuation of application No. PCT/EP2008/054253, filed on Apr. 9, 2008.

(30) Foreign Application Priority Data
Jun. 29, 2007 (DE) 10 2007 030 407.4

(51) Int. Cl. B32B 3/10; B32B 37/02; B32B 7/12; C08L 33/02

(52) U.S. Cl. 428/137; 156/273.3; 428/317.3; 525/329.7

(57) ABSTRACT

The invention relates to a method for gluing labels on hydrophobic substrates, wherein a radiation cross-linking, pressure-sensitive adhesive is applied on the label or on the substrate on a surface opposite to the label and irradiated with UV or electron radiation, and label and substrate are then brought together and glued to one another. The pressure-sensitive adhesive is soluble in aqueous solutions. The label is selected from i) water permeable labels with a water uptake (Cobb value) greater than 0.2 g/m² per 20 sec, and ii) perforated labels which have perforations or cut-outs of less than 10% on the glued surfaces. Furthermore, the invention describes a label, coated with a water-soluble, radiation curable, pressure sensitive adhesive, which has a high water uptake and/or optionally perforations or cut-outs on the glued surface.

This application is a continuation of International Application No. PCT/EP2008/054253, filed Apr. 9, 2008 and published on Jan. 8, 2009 as WO 2009/003737, which claims the benefit of German Patent Application No. 102007030407.4 filed Jun. 29, 2007, the contents of each of which are incorporated herein by reference in their entirety.

The invention relates to a method of adhesively bonding labels to substrates, in which the adhesive is a radiation-crosslinkable pressure-sensitive adhesive, which may be dissolved from the substrate surface by aqueous alkaline solutions. Furthermore, the invention relates to a label coated with a re-dissoluble radiation-crosslinkable pressure-sensitive adhesive, which may be adhesively bonded detachably to substrates with a hard surface. In addition, a radiation-crosslinkable pressure-sensitive adhesive soluble in aqueous solution is described.

WO 97/01483 describes an adhesive system for adhesively bonding labels, in which a liquid pick-up adhesive and an overlap adhesive are described, which stick the substrates together on-line. These are designed to be soluble in alkalis, i.e. the adhesive becomes detached in alkaline sodium hydroxide solution at elevated temperature and the label may thus be removed from the substrate. No more precise characterization of the labels to be adhesively bonded is provided.

U.S. Pat. No. 3,891,584 describes a water-dispersible hot-melt adhesive, which contains 75 to 95 parts of a graft copolymer, consisting of around 40-80% vinyl monomer and around 20-60 wt. % water-soluble polyalkylene oxide polymer, and 5-25 wt. % tackifying resin. The vinyl monomer is preferably vinyl acetate or a low molecular weight alkyl-substituted acrylate. The hot-melt adhesive serves inter alia for labeling reusable bottles at elevated speeds. The labels may be detached by brief softening in hot water.

WO 2004/069950 describes a method of attaching a transparent label to a substrate, in which the substrate material is present in the form of a film, which must have a defined water absorption value (Cobb value), and in which the film is intended to have a water vapor permeability of between 5 and 2000 g/m². The adhesive described is a liquid adhesive with a viscosity of between 1 and 500 Pas, aqueous glues based on starch, casein, EVA, PVA or other polymers being described as the adhesives. The labels have to have a high Cobb value, since the label material needs to absorb the moisture from the aqueous adhesive.

DE 102006042074, which has not yet been published, describes water-soluble hot-melt pressure-sensitive adhesives and the use thereof for adhesively bonding re-detachable labels. Selected water-permeable label materials are described therein, as are non-reactive thermoplastic adhesives.

It is known to perform the application of liquid, in particular aqueous adhesives to labels in such a way that the labels are coated with the adhesive on-line and stuck to the substrate immediately thereafter. This leads to delays in operation when labels are changed. If errors occur in adhesive application, the production process, of the bottles for example, is interrupted.

A further disadvantage of the known methods is that labels are often produced from films which are impermeable or only sparingly permeable to an aqueous washing liquor. This means that the washing liquor penetrates between label and substrate at the edge of the label and dissolves the adhesive at that location, but this does not generally lead to complete detachment of the label. Detachment of the label as above by alkaline aqueous solutions proceeds favorably with paper labels, but these are not transparent and are consequently less advantageous for many applications.

Furthermore, the application of hot-melt adhesives is complex, since the adhesive has to be warmed for the purpose and must not degrade during the processing time. This may lead to poor adhesion, and discoloration of the adhesive may also occur.

Taking the known adhesives and application methods as basis, the problem underlying the invention is that of providing a method of adhesively bonding labels in which any desired substrates, in particular water-repellent substrates, may be adhesively bonded to a label, in which method the label may be coated separately with a pressure-sensitive adhesive before adhesive bonding, and the adhesively bonded labels display good adhesion to the substrate in damp surroundings and may subsequently be removed completely from the substrate in an aqueous alkaline solution. In the process, the application conditions of the adhesive should expose the latter to as little stress as possible.

The solution according to the invention to this problem may be inferred from the claims. It consists substantially of a method in which suitable label material, which allows water to pass quickly through the surface, is coated with a suitable radiation-crosslinkable pressure-sensitive adhesive, the latter is crosslinked by actinic radiation and thereafter is adhesively bonded to a substrate, the adhesive having good water solubility.

The present invention further provides self-adhesive labels, which are coated with a water-soluble pressure-sensitive adhesive layer according to the invention. The invention further provides a radiation-curing pressure-sensitive adhesive, which displays sufficient water solubility in alkaline solution and allows complete redetachment of the adhesive from the substrate.

In this invention water-soluble should be taken to mean that the adhesive or an adhesive component is water-soluble, water-dispersible or emulsifiable. This may take place as a coarsely divided dispersion or indeed as a colloidal solution. Dissolution may generally be performed in an aqueous phase, preferably in alkaline solutions. The process may also be assisted by temperatures of up to 95° C. and preferably takes place at between around 50 and 90° C.

With the method according to the invention it is possible to apply the pressure-sensitive adhesive to the substrate, for example a bottle or can, and then to bond it adhesively to a label designed according to the invention. Preferably, however, the procedure is that the label is firstly coated with a suitable pressure-sensitive adhesive.

The pressure-sensitive adhesives to be used according to the invention are used for adhesive bonding to different substrates, in particular they are suitable for hydrophobic substrates which absorb little or substantially no water when wetted with alkaline washing solutions. These substrates comprise materials such as glass, metal, varnished or coated paper or corresponding paperboards and above all plastics, for example polyethylene terephthalate (PET), polycarbonate, polyethylene (PE), polypropylene (PP), polyvinyl chloride (PVC) or polystyrene. Containers may be made therefrom, such as hollow articles, cartons, films, crates or packaging. For the purposes of the present invention the substrates to be adhesively bonded comprise in particular rotationally symmetrical hollow articles, such as pots, cans, bottles, cartridges, or indeed cuboidal packaging. In particular, recyclable plastics materials, glass or metal materials may be adhesively bonded together with labels. Plastics moldings, such as crates or transport boxes, may also have removable labels adhesively bonded thereto.

The labels generally consist of thermoplastics in film form, such as polyethylene, polypropylene, polystyrene, polyvinyl chloride, or organic polymers, such as cellophane. In addition, the labels may however also consist of paper, optionally in the form of a composite with a polymer film. It is preferred to use labels made from a film based on nonpolar plastics, in particular on oriented polypropylene (OPP), with films of cellophane being particularly preferred. The films may be single or multilayer films. In particular, optically transparent films may be used as the label material. No particular requirements apply with regard to the shape of the labels. They may be quadrilateral, round or have other shapes. They may for example be ordinary or wrap-around labels.

In particular, the labels may consist of organic polymers such as cellophane for example. Cellulose occurs widely in nature. It is a biopolymer of β-1,4-linked cellobiose units. Conventionally, cellulose forms unbranched, water-insoluble chains. The molar weight may amount to between 50,000 and 500,000 g/mol (determinable by the GPC method). Known technical methods are used to produce a viscose solution from cellulose, which may be processed into films. By selecting the materials used appropriately, it is possible to use cellulose films also for packaging foodstuffs.

The films may be colored, printed, metallized, colorless or transparent films. Single or multilayer films may be used. Conventionally, the films have a film thickness of between 5 and 300 μm, in particular between 10 and 150 μm. Films and methods for the production and treatment of such films are known to the person skilled in the art.

According to the invention the films, for example a single or a multilayer film, have to have a Cobb value (20 sec.) of over 0.2 g/m² per 20 sec, in particular over 0.5 g/m² per 20 sec. The Cobb value of a substrate indicates the speed at which liquid water is absorbed by the substrate. Measurements to determine the Cobb value are specified by DIN-EN 20 535 (20° C.). The measurement duration should cover the first 20 sec., water absorption not being constant over longer measurement periods.

The higher the Cobb value, the greater the water absorption capacity of the label material. For the purposes of the invention, the Cobb value (20 sec.) should generally be below 50 g/m² per 20 sec, preferably below 20 g/m²/min. If too high a Cobb value is selected, the label stuck to the substrate is susceptible to high atmospheric humidity, condensation or rain and does not produce a lasting, suitable adhesive bond with the substrate. Furthermore, the label has to absorb water quickly, since the washing processes in conventional industrial bottle recycling plants have only a limited residence time. The measurement duration of 5 min. indicated in WO 2004/069950 does not produce any results suitable for practical purposes.

Another embodiment of the invention consists in the suitable label material being perforated, i.e. having holes or cut-outs over the surface. The perforated area should amount to less than 10% of the area of the label coated with the adhesive, in particular to between 0.01 to 5%, in particular to less than 1%. Care should be taken to ensure that perforation takes place as uniformly and evenly as possible, and it is moreover preferred for the perforation holes or cut-outs to be small in relation to the perforated area. In particular, a relatively large number of perforation holes with relatively small areas is preferred. In particular, the perforation holes should be smaller than 1 mm, in particular smaller than 0.5, very particularly preferably smaller than 0.2 mm. The spacing between the perforations should be dimensioned such that the washing solution may quickly find its way through the perforation holes to between the adhesively bonded label and substrate surface. The spacing may therefore amount to under 10 mm, in particular under 5 mm. This embodiment may also be used in addition to selection of the label material.

If a sufficient number of perforation holes is present, labels may also be used which have a lower Cobb value than 0.3 g/m² per 20 sec. The label may then be redetached by the washing solution as a result of diffusion starting at the edges or the perforated openings of the label. Labels which are particularly suited to being perforated are transparent labels for adhesive bonding to transparent substrates, as in this case the perforated surface does not make any further visual impression.

Furthermore, the penetration of water into the adhesive layer may be assisted by mechanical modifications. If marginal areas of the label undulate outwards, the wettable surface area is increased. If the length of a label increases in the washing process, wrinkles may form, thereby allowing the washing liquid to encroach under them quickly.

The present invention thus provides labels which are coated with a pressure-sensitive adhesive suitable according to the invention. The material of the labels should exhibit rapid water absorption or allow good water permeability by way of openings or perforations in the labels. If label material is selected with a high Cobb (20 sec.) value, the water solubility of the adhesive may be lower, whereas if the water absorption is lower, the solubility of the adhesive must be greater.

The suitable pressure-sensitive adhesive according to the invention comprises a pressure-sensitive adhesive soluble or dispersible in aqueous solution and based on 70 to 95 wt. % of at least one radiation-crosslinkable base polymer, 5 to 30 wt. % of at least one resin, 0 to 30 wt. % of conventional auxiliary substances and additives, the total of the components amounting to 100 wt. %.

Base polymers are understood to be synthetic polymers, characteristics important for hot-melt adhesives such as adhesion, strength and temperature behavior thereby being substantially predefined. Such polymers may for example be polycondensation products, such as polyamide resins, copolyamides, polyetheramides, polyesteramideimides, polyetheresteramides, polyesteramides and polyesters; polymers such as ethylene, ethylene/vinyl acetate, ethylene/acrylate, propylene, (meth)acrylate copolymers; styrene copolymers, such as SIS, SBS, SIBS, SEBS copolymers; amorphous or metallocene-catalyzed PE or PP homo- or copolymers; polyadducts, such as optionally linear, non-reactive polyurethanes. Polymers are preferred which may be obtained by free-radical polymerization. Polymers based on (meth)acrylic acid esters are particularly suitable. According to the invention, these polymers must still comprise unsaturated double bonds and may crosslink by radiation. It is additionally preferable for the polymers in the polymer chain to comprise functional groups which may act as initiators in the radiation reaction.

The quantity of base polymer should preferably amount to between 75 and 90 wt. %, relative to the pressure-sensitive adhesive overall. There may be just one base polymer or indeed a plurality thereof may also be used in a mixture. The polymers may also comprise groups which have hydrophilic properties and enhance solubility in aqueous solutions. These may be directly incorporated by polymerization during synthesis through selection of the monomers, but it is also possible to incorporate them by reaction by subsequent modification of the polymer backbone. It is particularly preferable if, due to the group acting by chance as initiator, those polar groups are formed which bring about solubility of the base polymer. The groups may be polar groups, or they may also be groups convertible into ionic groups.

It is optionally possible for between 0 to 40%, in particular up to 30%, relative to the base polymer of a further polymer to be contained in the pressure-sensitive adhesive, which further polymer comprises polar groups. Particular preference is here given to OH-group-terminated polyurethanes, polyesters containing carboxyl groups or sulfonic acid groups, acrylate copolymers containing carboxyl groups. These polymers should comprise a large number of polar groups. Examples thereof are polyesters based on aromatic dicarboxylic acids such as phthalic acid or terephthalic acid, with at least one polyol from the group comprising neopentyl glycol, glycerol, pentaerythritol or low molecular weight polyether polyols, the following being particularly preferred: esters based on aromatic dicarboxylic acids containing sulfo groups; (meth)acrylic acid homo- and/or copolymers based on (meth)acrylic esters with C₁ to C₁₂ alkanols; polyvinyl alcohol with a molar mass of over 1000 g/mol and/or polyvinyl alkyl ethers with 1 to 14 atoms in the alkyl group; polyurethanes with at least one terminal OH group, with a softening point of between 50 and 120° C.

Apart from the base polymers, at least one resin must also be contained in the hot-melt pressure-sensitive adhesive. Such resins make the adhesive permanently tacky and improve compatibility of the hot-melt adhesive components. This resin is generally used in an amount of from 5 to 30 wt. %. Said resin comprises for example hydroabietyl alcohol and the esters thereof, in particular the esters thereof with aromatic carboxylic acids such as terephthalic acid and phthalic acid; preferably modified natural resins such as resin acids from gum resin, tall oil resin or wood resin, for example fully saponified gum resin, or alkyl esters of optionally partially hydrogenated rosin with low softening points, such as for example methyl, diethylene glycol, glycerol and pentaerythritol esters; acrylic acid copolymers, preferably styrene/acrylic acid copolymers and resins based on functional hydrocarbon resins. Derivatives of such resins may also be used, such as disproportionated, partially hydrogenated or hydrogenated resins or resins modified by saponification or transesterification.

The resins suitable according to the invention should ensure good adhesion. The known resins may be selected. In particular they may also optionally additionally exhibit good water solubility. This may be influenced by ionic groups or by groups convertible into ionic groups and/or polar groups on the resin. If such resins are selected, the acid value should amount disproportionate between 90 and 220 mg of KOH/g (according to DIN 53 402). A high acid value may increase the solubility of the adhesive. In this case it is then possible to increase solubility such that redissolution of the adhesive layer may also be achieved in heated water, optionally assisted by surfactants. Resins with and without acid groups are known to the person skilled in the art.

Resin components suitable for use according to the invention are preferably wholly or partially hydrogenated or unmodified rosin glycerol esters. Another embodiment uses rosin-formaldehyde reaction products, which preferably have an acid value of at least 120, in particular of 140 to 200 mg of KOH/g. The softening point of the resins should amount to at least 50° C., preferably to from 65 to 85° C. (according to DIN 52011). One resin may be used or also mixtures.

The quantity of the resin in the pressure-sensitive adhesive should preferably be from 10 to 25 wt. %, relative to the hot-melt adhesive overall, in order to bring about rapid detachment of the label from the substrate surface.

The additives used in the hot-melt pressure-sensitive adhesives according to the invention may be the known additives and auxiliary substances. These are for example waxes, fillers, softeners, initiators, stabilizers, antioxidants and/or dyes.

The plasticizers used may be the known, non-reactive plasticizers. The plasticizer is contained in the hot-melt adhesive in general in a concentration of from 0 to 30, preferably in a concentration of up to 20 wt. %.

Suitable plasticizers are mono- or polyhydric alcohols, preferably glycol monophenyl ether, hexamethylene glycol, glycerol and in particular polyalkylene glycols with a molar mass of from 200 to 6000 g/mol, in particular up to around 1000, preferably up to around 600. Esters may also be used as plasticizers, for example liquid polyesters and glycerol esters. Finally, alkyl monoamines and fatty acids with preferably 8 to 36 C atoms may also be used. White oil and naphthenic mineral oil are also suitable.

Plasticizers with hydrophilic groups are preferably used, in particular polyalkylene glycols and derivatives. White oils are preferred for applications associated with foodstuffs packaging.

Fillers may be used to improve application- or adhesion-related properties. These are solid, inert substances, such as for example chalk, titanium dioxide, silicon dioxide or other generally colorless pigments. it is necessary in this case to ensure that the radiation-crosslinkable reaction is not impaired. The proportion in the pressure-sensitive adhesive is generally below 10 wt. %, in particular no filler is contained therein.

Natural, chemically modified or synthetic waxes may be added to the pressure-sensitive adhesive as further components. Any waxes may be used in this case which are compatible with the base polymer. The natural waxes used may take the form of vegetable waxes, animal waxes, mineral waxes or petrochemical waxes. The chemically modified waxes used may take the form of hard waxes, such as montan ester waxes, Sasol waxes etc. Polyalkylene waxes and polyethylene glycol waxes are used as synthetic waxes, in particular, petrochemical waxes such as petroleum jelly, paraffin waxes, micro waxes and synthetic waxes, in particular polyethylene waxes with melting points of between 85 and 140° C., paraffin waxes with melting points in the range from 45 to 70° C., microcrystalline waxes with melting points in the range from 60 to 95° C. and synthetic Fischer-Tropsch waxes with melting points in the range from 100 to 115° C. are preferably used. The quantity of waxes in the pressure-sensitive adhesive amounts in general to 0 to 25, preferably 0 to 10 wt. %.

Stabilizers are a further auxiliary substance which may be present. They have the task of preventing the reactive monomers from undergoing an undesired or premature reaction and of protecting the polymers from degradation during processing. They are conventionally added to the pressure-sensitive adhesive in quantities of up to 2 wt. %, preferably in quantities of around 0.1 to 1.0 wt. %

Initiators may also optionally be contained in the pressure-sensitive adhesive. These are intended to accelerate crosslinking by actinic radiation. In the case of UV radiation in particular, such initiators are convenient. In a particular configuration, groups which may act as initiators are attached by reaction to the base polymer. The suitable additives and auxiliary substances are known to the person skilled in the art.

The present invention further provides a pressure-sensitive adhesive consisting of 70 to 95 wt. % of at least one base polymer, which must contain radiation-crosslinkable groups, 5 to 30 wt. % of at least one resin, 0 to 40% relative to the base polymer of an additional polymer, which comprises hydrophilic and/or ionic groups, from the group of polyesters, polyurethanes, poly(meth)acrylic acid alkyl esters, acrylic acid homo- and/or copolymers and/or vinyl polymers, and 0 to 30 wt. % of conventional auxiliary substances and additives, the total of the components amounting to 100 wt. %. This adhesive is viscous at 25° C. or it may be a hot-melt adhesive. After application onto the substrate, the adhesive undergoes crosslinking by actinic radiation, for example UV or electron beam radiation. The radiation is selected such that the pressure-sensitive adhesive undergoes a crosslinking reaction, i.e. higher molecular weight and optionally branched polymer chains form. The crosslink density may be influenced by way of radiation intensity. Crosslinking should not in general be complete, i.e. the polymer must still be soluble or dispersible in water. Without wishing to be attached to a theory, only partial crosslinking of the polymer is involved. The irradiation intensity should preferably be below 200 mJ/cm², in particular from 15 to 160 mJ/cm². The irradiation may be selected by a person skilled in the art as a function of the number of crosslinkable groups and the intended degree of crosslinking.

In a preferred embodiment, the base polymer is a poly(meth)acrylic ester copolymer, which contains one or more groups acting as initiators on the polymer chain. These react through radiation, resulting in functional groups, such as COOH, OH, or NH groups, which impart high water solubility to the polymer.

The pressure-sensitive adhesive according to the invention is in general colorless. It is preferably solvent-free. It may be viscous at room temperature, but for application it is conventionally heated. Its viscosity should amount in particular to from 300 mPas to 50,000 mPas at 130° C. (measured to Brookfield, EN ISO 2555), in particular to from 5000 to 35,000 mPas. The viscosity may be selected in accordance with the adhesive application method. Relatively low viscosity is needed for roller application, while slot nozzle application is also capable of processing a high viscosity. The pressure-sensitive adhesive displays good detachment behavior, i.e. adhesion to the substrate is reduced on contact with the washing solution.

The pressure-sensitive adhesives usable according to the invention may be produced by known methods. For example it is possible to heat or melt the base polymers. Mixing with the further adhesive constituents may then be performed at elevated temperature with stirring. After homogenization the adhesives may be packaged and cooled. The adhesives may be packaged in suitable packaging which simplifies handling in the pressure-sensitively adhesive state. Such production methods and suitable types of packaging are known to the person skilled in the art. In one embodiment the adhesives are also present as hot-melt adhesives, i.e. they are solid at room temperature.

The pressure-sensitive adhesives according to the invention may be applied using known methods. The material of the labels (a film, a multilayer film or paper) may be processed in webs. These webs may for example be subjected to surface pretreatment. It is known to print or emboss such webs, to laminate them to form multilayer films or to apply other methods to produce a high quality surface and a suitable visual appearance. A hot-melt pressure-sensitive adhesive according to the invention is then applied to the back of the webs.

Application may take place over the entire webs, i.e. the whole surface is uniformly coated. In another procedure the hot-melt adhesive is applied only to individual parts of the webs. This may take place for example in stripes, or other patterns are applied to the web surface, and may be performed for example by coating knife applicators, slot dies, pressure applicators, spray application, roller application or curtain, frame, kiss or roller coating. After application of the pressure-sensitive adhesive, the adhesive layer is crosslinked by irradiation. A pressure-sensitively adhesive layer arises. Then the web may be cut to size to yield suitable labels.

In another procedure the optionally printed labels are formed in a first step. These may then be provided on the back with a hot-melt pressure-sensitive adhesive. In the process, the labels may be coated all over, stripes are applied, in particular at the label edge, or any desired pattern may be applied. The quantity of pressure-sensitive adhesive should amount to from 2 to 100 g/m², in particular from 5 to 50 g/m². In this case, the adhesive should be present in liquid or molten form. The application temperature should amount to from 25 to 170° C. In the case of thermally sensitive substrates, application may also take place at relatively low temperatures, preferably up to 140° C.

Where the label is designed as an at least partially perforated area, perforation may be performed at various times.

For example it is possible for the web-type material to be perforated before or after printing. It is also possible, however, for the labels to be perforated once printed or optionally coated with adhesive. Perforation may be selected on an aesthetic basis, it is merely necessary as an essential feature of the invention for sufficient perforations to be provided over the area coated with the hot-melt pressure-sensitive adhesive.

A preferred procedure is generally to apply a protective film onto the side already coated with the pressure-sensitive adhesive before or after the labels have been cut to size. This protective film has the task of preventing the labels from sticking together. Before actual sticking on of the label the protective film (release liner) is removed. Such protective films may consist of plastics films, nonstick coated papers also being generally known.

In a further embodiment of the method the pressure-sensitive adhesive is applied to a nonstick coated backing, for example a silicone paper, a siliconized film or a Teflon film. The adhesive layer may then be irradiated. The labels are then applied individually to this adhesive layer or as a printed or unprinted film web. This results in coated labels which are provided with a separable protective layer on the adhesive side.

According to the invention it is possible to stick the coated labels to the substrates on-line. In this way, storage of the labels and the additional operations of rolling up and packaging the labels is avoided. However, in a procedure preferred according to the invention the side of the label already coated with the pressure-sensitive adhesive is covered with a protective film and brought into a form which enables storage. This may for example involve stacked storage or rolling up of the labels on a backing material, in particular on the protective film. Immediately before use for adhesive bonding, the labels are removed from the backing material and stuck to the substrate.

The labels produced according to the invention may be made from polymers or paper, in particular from cellophane. A further preferred embodiment uses translucent or transparent, clear materials as film material. The pressure-sensitive adhesive according to the invention should preferably likewise be clear and have no inherent color when in a thin layer.

Detachment of adhesively bonded labels in aqueous solution is known. For example, the substrates stuck to a label, for example. bottles, are detached therefrom in a bottle cleaning machine in an approximately 1% to 5% NaOH or KOH solution at a temperature of from 40 up to 95° C. The detachment process should take place as quickly as possible, since the duration of the washing process is generally under 5 min. The aqueous solution may contain additives which assist in detachment, such as surfactants, antifoaming agents, floatation agents, or simplify processing. It is optionally also possible to use additional means which assist in detachment, such as fluid flow, mechanical loading or thermal deformation of the labels.

In the cleaning process the labels coated according to the invention enable the cleaning solution to arrive quickly by way of the substrate at the adhesively bonded surface. The adhesive is dissolved by the heat and by intensive contact with the washing solution and loses its adhesive strength. It should be noted in particular that the adhesive is dissolved from the substrate surface, i.e. the substrate surface is usually free of attached adhesive. The solubility of the adhesive is preferably selected such that it is not completely water-soluble, but rather only loses its adhesion to the substrate. The cleaning means present in the washing solution and in the method then make it possible to remove large proportions of the adhesive from the washing solution together with the labels. Per se known additives in the cleaning solution may assist in dissolution of the adhesive and separation from the aqueous solution. This simplifies reuse of the washing solution and means that increased environmental compatibility may be achieved by the method of adhesive bonding according to the invention. It is preferable for the adhesive to display a lower density than the washing solution in its emulsified form. Thus, the adhesive and the detached label parts float on the washing liquid and may be separated better.

The method according to the invention is used in particular in packaging, i.e. for labeling cartons, hollow articles and film packaging or outer packaging, such as crates.

A particularly advantageous use according to the invention is the recycling of disposable bottles or reusable bottles of glass or PET. With the method according to the invention the contact time with the washing liquor may be reduced, the concentration of the base may optionally be reduced and the washing temperature lowered. By using the adhesive suitable according to the invention, the surface of the substrates is less contaminated or not contaminated at all with adherent adhesive residues. The substrates may be complete bottles, but parts of such containers may also be processed accordingly, in the form of shredded plastics.

In another embodiment pressure-sensitive adhesives are used which have elevated water solubility and high solubility of the base polymer and of the resin. In this case it is possible for the adhesively bonded labels to be dissolved not only in alkaline solutions but also in water, optionally in surfactant-containing solutions, at temperatures of between 40 and 70° C.

By selecting suitable film material for the labels in conjunction with the pressure-sensitive adhesives suitable according to the invention, it is possible to achieve nonslip, stable adhesive bonding of labels to substrates, in particular hard, water-repellent substrates, even in the presence of moisture. These may however be readily removed under known conditions in alkaline aqueous solution. Substrate surfaces with only small amounts of adhesive residues are then obtained.

Example of radiation-curing pressure-sensitive adhesive:

90 parts by weight of a copolymer based on acrylate esters with initiators attached by reaction (AC Resin A 204 UV) are melted with 10 parts by weight of a resin (Foral 85 E) with stirring at approx. 120° C. to 160° C. and homogenized. The hot-melt adhesive is portioned and cooled. A slightly opaque mass is formed.

Example of adhesive bond:

The adhesive melted at 120° C. is applied to a label (7×5 cm) of a cellophane-based film, film thickness 125 μm, Cobb value 0.55 g/m² per 20 sec, with a coating knife in a film thickness of 12 g/m². The adhesive film is irradiated with 60 mJ/cm². The label is stuck in each case to a test specimen of aluminum, glass and PET.
The adhesive bond is stable for over 5 hours in a condensed water test. One test specimen is subjected to a wash-off test at 80° C. . After 5 mins. complete detachment of the label may be observed.

Comparative example of adhesive bond:

The same hot-melt adhesive is applied to a cellophane label of the same thickness with a Cobb value of 0.15 g/m² per 20 sec. The label is adhesively bonded and tested for detachment in an alkaline medium. After 4 min of the wash-off test the adhesive bond/label is for the most part still not detached.

A comparison of the Cobb values of the films over longer test cycles results in unsuitable selection criteria.

Film according to the invention: Cobb (60 sec) 0.95 g/m² per 60 sec.
Comparison film: Cobb (60 sec) 1.15 g/m² per 60 sec.

Wash-off test:

A container with 2% aqueous NaOH is stirred and heated to 80° C. A coated test specimen is immersed and turned with a slow oscillating motion. The time is determined at which the label becomes detached.

Condensed water test:

A test specimen cooled on the inside to 4° C. is placed in an atmosphere saturated with water at a temperature of 40° C. The stability of the adhesive bond is assessed.

1. A method of adhesively bonding labels to hydrophobic substrates, in which a radiation-crosslinkable pressure-sensitive adhesive is applied to all or part of the label or of the substrate on a surface facing the label, and label and substrate are brought together and adhesively bonded, wherein prior to adhesive bonding the pressure-sensitive adhesive is crosslinked by irradiation with actinic radiation to yield an adhesive layer, wherein said adhesive layer is soluble in aqueous solution and the label is selected from i) water-permeable labels with a water absorption (Cobb value) greater than 0.2 g/m² per 20 sec, ii) perforated labels, which have perforations or cut-outs over less than 10% of the adhesively bonded areas.

2. The method according to claim 1, wherein irradiation is performed with UV radiation or with electron beam radiation.

3. The method according to claim 1, wherein the label is printed.

4. The method according to claim 1, wherein the label is a transparent label.

5. The method according to claim 1, wherein the label is a cellophane label.

6. The method according to claim 1, wherein the pressure-sensitive adhesive is applied at a temperature of between 20 and 170° C., preferably onto the label.

7. The method according to claim 1, wherein the pressure-sensitive adhesive is soluble in alkaline solutions at temperatures of between 40 to 95° C..

8. The method according to claim 1, wherein after irradiation the pressure-sensitive adhesive contains functional groups which bring about solubility in water.

9. (canceled)

10. The method according to claim 1, wherein the water absorption of the label is greater than 0.5 g/m² per 20 sec up to 50 g/m² per 20 sec and/or comprises a perforated area of less than 1%, the perforation holes being smaller than 0.2 mm.

11. The method according to claim 1, wherein a redetachable protective layer (release liner) is applied to the label after application of the adhesive and crosslinking and the label may be stored.

12. A label coated with a pressure-sensitive adhesive crosslinkable by actinic radiation, which adhesive is soluble or dispersible in aqueous solution under heat, wherein the label is i) water-permeable with a water absorption (Cobb value) of greater than 0.3 g/m² per 20 sec, and/or ii) has perforations or cut-outs over less than 10% of the adhesively bonded areas.

13. The label according to claim 12, wherein the water absorption is between 0.5 g/m² per 20 sec and up to 50 g/m² per 20 sec and/or the area of the perforation holes amounts to between 0.1% and 1% of the area coated with the adhesive.

14. The label according to claim 12, wherein the pressure-sensitive adhesive contains 5 to 30 wt. % of a resin and 95 to 70 wt. % of a base polymer, which comprises radiation-crosslinkable groups.

15. The label according to claim 12, wherein the pressure-sensitive adhesive contains up to 90 wt. % of a polymer with radiation-crosslinkable groups, and additionally groups which initiate crosslinking.

16. The label according to claim 12, wherein the label consists of a plastics or cellophane film or of paper.

17. The label according to claim 12, wherein the adhesive contains a resin with an acid value of between 90 and 220 mg of KOH/g, in particular 120 and 200 mg of KOH/g.

18. The label according to claim 12, wherein the label is provided with a removable protective film on the side coated with the adhesive.

19. A water-soluble pressure-sensitive adhesive for adhesively bonding labels, wherein the pressure-sensitive adhesive contains at least 70 to 95 wt. % of a base polymer, which is crosslinkable by actinic radiation, and 5 to 30 wt. % of a resin, wherein after irradiation the base polymer comprises groups promoting water solubility, and optionally further additives.

20. The water-soluble pressure-sensitive adhesive according to claim 19, wherein after crosslinking the base polymer comprises polar groups, ionic groups or groups convertible into ionic groups.

21. The water-soluble pressure-sensitive adhesive according to claim 19, wherein it contains the resin in an amount of between 10 and 25 wt. %, with an acid value of between 90 and 220 mg KOH/g, and a base polymer in an amount of between 75 and 90 wt. %.

22. The water-soluble pressure-sensitive adhesive according to claim 19, wherein the base polymer is selected from polyacrylates or polymethacrylates which comprise crosslinkable groups and groups which initiate crosslinking.

23. The water-soluble pressure-sensitive adhesive according to claim 19, wherein the adhesive is crosslinked or partially crosslinked by UV radiation or electron beam radiation.

24. (canceled)

25. (canceled)
